(19) United States
(12) Patent Application Publication
(10) Pub. No.: US 2022/0363020 A1
(43) Pub. Date: Nov. 17, 2022

(54) METHOD FOR MANUFACTURING MOLDED COMPOSITE

(71) Applicant: ADVANCED INTERNATIONAL MULTITECH CO., LTD., Kaohsiung City (TW)

(72) Inventors: Yuan-Jen HOU, Kaohsiung City (TW); Chi-Nan HSIAO, Kaohsiung City (TW)

(21) Appl. No.: 17/510,970

(22) Filed: Oct. 26, 2021

(30) Foreign Application Priority Data
May 13, 2021 (TW) 110117286

(51) Int. Cl. B29C 70/46; B29C 70/54; B29C 33/68

(52) U.S. Cl. CPC B29C 70/46; B29C 70/54; B29C 33/68; B29K 2905/00

(57) ABSTRACT

A method for making a molded composite includes the steps of providing a lower mold that has an upward depressed surface having first and second surface regions and an interconnecting region, placing a mold release film on the upward depressed surface to cover at least the first and second surface regions and the interconnecting region, placing a molding material on the mold release film such that the mold release film is disposed between the upward depressed surface and the molding material, and hot pressing the molding material by pressing a downward pressing region of an upper mold toward the upward depressed region of the lower mold so as to form the molding material into a molded composite.

### CROSS-REFERENCE TO RELATED APPLICATION

This application claims priority of Taiwanese Invention Patent Application No. 110117286, filed on May 13, 2021.

### FIELD

The disclosure relates to a method for manufacturing a molded composite, and more particularly to a method for manufacturing a molded composite using a lower mold that has a negative draft angle.

### BACKGROUND

In a thermoforming process for manufacturing a molded composite, a conventional mold including a lower mold and an upper mold is generally used. First, a molding material is placed on the lower mold. Then, the upper mold is combined with the lower mold so as to position the molding material in a mold cavity between the upper and lower molds. Afterwards, the molding material is pressed between the upper and lower molds at a predetermined temperature so as to permit the molding material to deform and fill the mold cavity, thereby obtaining the molded composite. After the upper and lower molds are separated from each other, the molded composite could be demolded.

In the case that the molded composite has a tapered profile toward a bottom thereof, the molded composite can be easily removed from a mold, and generally refers to an article having a positive draft angle. On the contrary, in the case that the molded composite is brought into interference engagement with a mold during a demolding procedure, the molded composite refers to an article having a negative draft angle.

Therefore, it is usual to avoid designing an article with a negative draft angle when the article is made using a molding process. However, with an increased demand for diversification of product appearance, the molded composite is inevitably designed to have a negative draft angle, which might interfere with a mold during the demolding procedure, and thus increases the difficulty for performing the demolding procedure.

### SUMMARY

Therefore, an object of the disclosure is to provide a method that can alleviate or eliminate at least one of the drawbacks of the prior art.

According to the disclosure, a method for making a molded composite includes the steps of:
a) providing a lower mold which has an upward depressed surface, and which defines a reference line normal to a bottom surface of the lower mold, the upward depressed surface having
   a first surface region having a first edge most distal from the reference line,
   a second surface region located at the same side as the first surface region relative to the reference line, the second surface region having a second edge which is most proximate to the reference line and which is located at a level higher than that of the first edge, the second edge being closer to the reference line compared with the first edge, and
   an interconnecting region interconnecting the first edge of the first surface region and the second edge of the second surface region;
b) placing a mold release film on the upward depressed surface to cover at least the first surface region, the second surface region, and the interconnecting region;
c) placing a molding material on the mold release film such that the mold release film is disposed between the upward depressed surface and the molding material; and
d) hot pressing the molding material by pressing a downward pressing region of an upper mold toward the upward depressed region of the lower mold so as to form the molding material into a molded composite.

### BRIEF DESCRIPTION OF THE DRAWINGS

Other features and advantages of the disclosure will become apparent in the following detailed description of the embodiments with reference to the accompanying drawings, of which:

FIG. 1 is a flow diagram illustrating a method for manufacturing a molded composite in accordance with an embodiment of the disclosure;

FIG. 2 is an exploded view of a mold used for manufacturing the mold composite;

FIG. 3 is a fragmentary enlarged view of area AA in FIG. 2;

FIGS. 4 to 7 are schematic sectional views illustrating consecutive steps of the method for manufacturing the molded composite in accordance with the embodiment of the disclosure;

FIG. 8 is a schematic sectional view illustrating an upper mold being removed from a lower mold; and

FIG. 9 is a view similar to that shown in FIG. 8 but illustrating another way for removing the upper mold.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

To aid in describing the disclosure, directional terms may be used in the specification and claims to describe portions of the present disclosure (e.g., front, rear, left, right, top, bottom, etc.). These directional definitions are intended to merely assist in describing and claiming the disclosure and are not intended to limit the disclosure in any way.

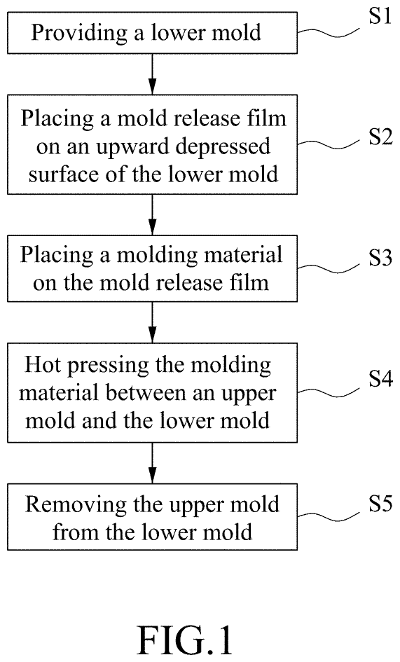

Referring to FIG. 1, a method for manufacturing a molded composite is illustrated in accordance with an embodiment of the disclosure. The method may include consecutive steps from step S1 to step S5.

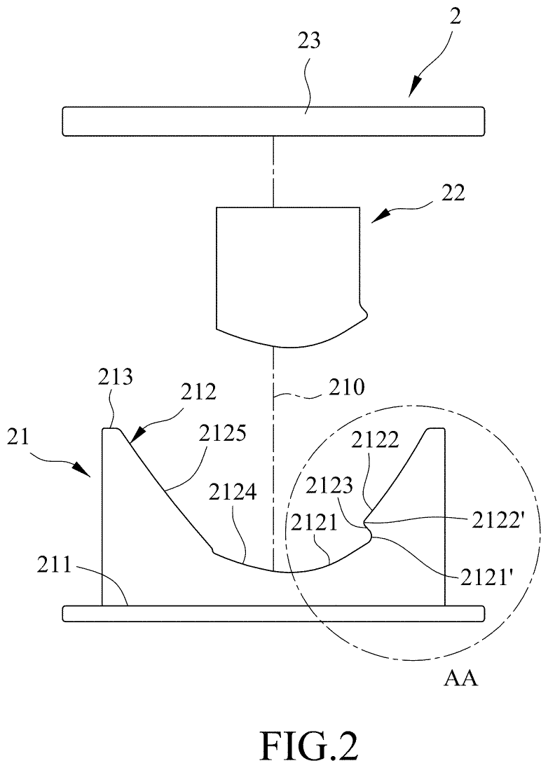

Referring to FIG. 2, a mold 2 used for manufacturing the molded composite includes a lower mold 21 and an upper mold 22. In some embodiments, the mold 2 may further include a pressing plate 23.

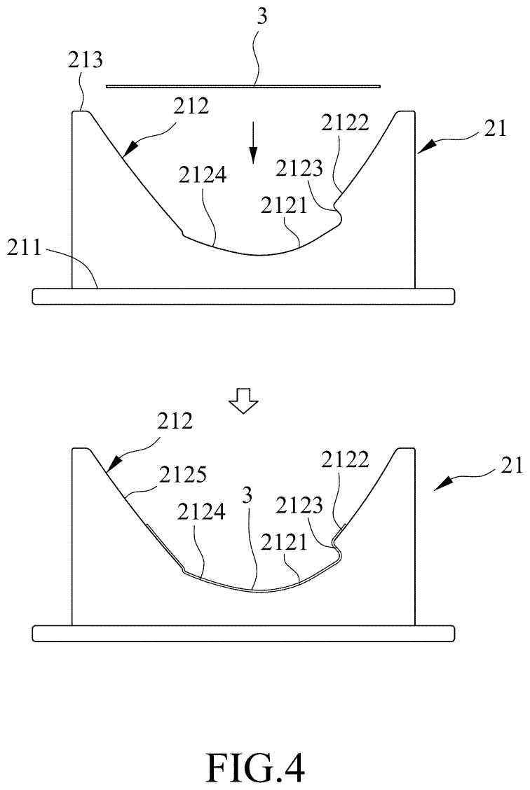

In step S1, as shown in FIGS. 2 and 4, the lower mold 21 is provided. The lower mold 21 has a bottom surface 211, a top surface 213 opposite to the bottom surface 211 and an upward depressed surface 212 depressed from the top surface 213 toward the bottom surface 211. The lower mold 21 defines a reference line 210 normal to the bottom surface 211.

The upward depressed surface 212 has a first surface region 2121, a second surface region 2122, and an interconnecting region 2123 interconnecting the first and second surface regions 2121, 2122.

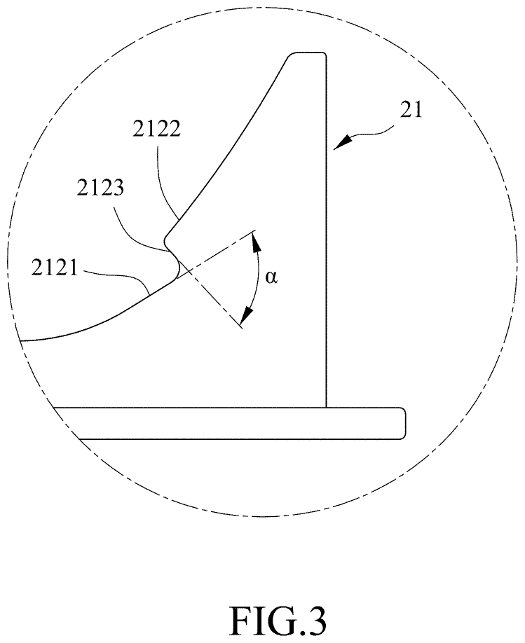

The first surface region 2121 has a first edge 2121′ most distal from the reference line 210. The second surface region 2122 is located at the same side as the first surface region 2121 relative to the reference line 210, and has a second edge 2122′ that is most proximate to the reference line 210. The second edge 2122′ is located at a level higher than that of the first edge 2121′, and is closer to the reference line 210 compared with the first edge 2121′. The interconnecting region 2123 interconnects the first edge 2121′ of the first surface region 2121 and the second edge 2122′ of the second surface region 2122. The first surface region 2121, the second surface region 2122 and the interconnecting region 2123 cooperatively define a contour for mating an article with a negative draft angle. In some embodiments, as shown in FIG. 3, an included angle (a) between the first surface region 2121 and the interconnecting region 2123 is less than 90 degrees.

In some embodiments, as shown in FIG. 2, the upward depressed surface 212 further has an extended surface region 2124 and a guiding region 2125. The extended surface region 2124 extends from the first surface region 2121 in a direction away from the interconnecting region 2123, and is located to permit the reference line 210 to extend therethrough. The guiding region 2125 extends from the extended surface region 2124 in the direction away from the interconnecting region 2123. In some embodiments, the guiding region 2125 may be arranged substantially parallel to the interconnecting region 2123.

In step S2, as shown in FIG. 4, a mold release film 3 is placed on the upward depressed surface 212 of the lower mold 21 to cover at least the first surface region 2121, the second surface region 2122 and the interconnecting region 2123. In some embodiments, the mold release film 3 is placed to further cover the extended surface region 2124 and the guiding region 2125.

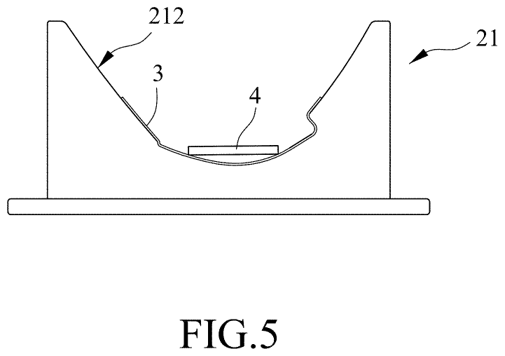

In step S3, as shown in FIG. 5, a molding material 4 is placed on the mold release film 3 such that the mold release film 3 is disposed between the upward depressed surface 212 of the lower mold 21 and the molding material 4. In some embodiments, the molding material 4 may be a resin impregnated material, such as a resin impregnated fiber material or other suitable materials, and may be formed as a sheet or a block.

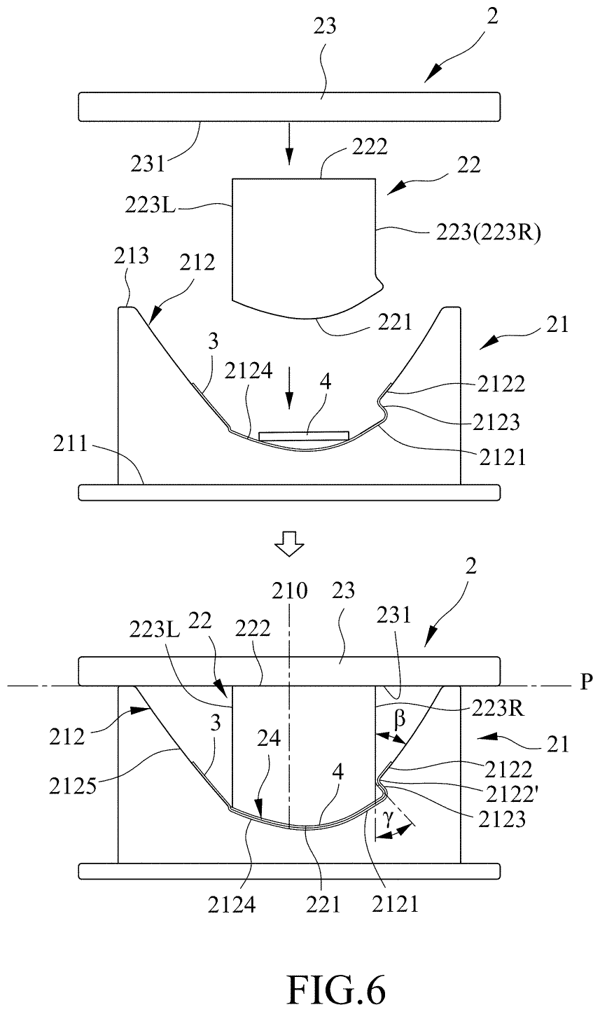

In step S4, as shown in FIG. 6, the molding material 4 is hot pressed by pressing a downward pressing region 221 of the upper mold 22 toward the upward depressed region 212 of the lower mold 21. In some embodiments, the downward pressing region 221 of the upper mold 22 has a contour configured to hot press the molding material 4 together with the first surface region 2121, the interconnecting region 2123 and the extended surface region 2124 of the lower mold 21. In addition, a mold cavity 24 for hot pressing the molding material 4 is defined between the upper mold 22 and the lower mold 21.

In some embodiments, the upper mold 22 further includes an upper surface 222 opposite to the downward pressing region 221, and a peripheral surface 223 connected to the upper surface 222 and the downward pressing region 221. The peripheral surface 223 has a left-hand side region 223L facing the guiding region 2125 and a right-hand side region 223R facing the second surface region 2122. In some embodiments, the reference line 210 is also normal to a plane (P) where the top surface 213 of the lower mold 21 and the upper surface 222 of the upper mold 22 are coplanar during step S4.

In some embodiments, as illustrated in FIG. 6, when the upper mold 22 and the lower mold 21 are combined, the left-hand side region 223L and the right-hand side region 223R are respectively spaced apart from the guiding surface 2125 and the second surface region 2122. In this situation, an included angle cm is formed between the right-hand side region 223R and the second surface region 2122, and an included angle (γ) is formed between the interconnecting region 2123 and an imaginary surface extending downwardly from the right-hand side region 223R. The angle (β) is not less than the angle (γ).

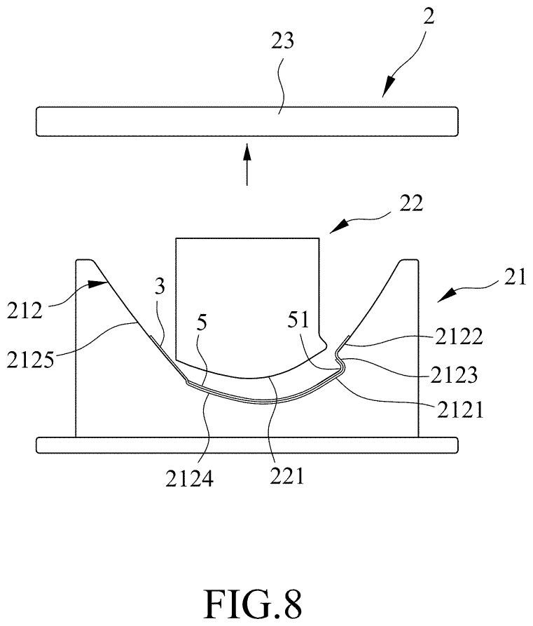

In some embodiments, in step S4, the upper mold 22 may be guided by the guiding region 2125 to move inclinedly and downwardly (see also FIG. 8) so as to permit the upper mold 22 to be combined with the lower mold 21.

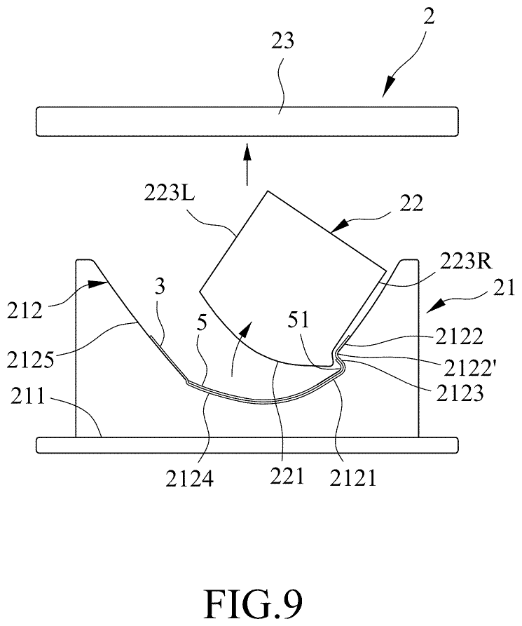

In alternative embodiments, in step S4, after the right-hand side region 223R is brought into contact with the second surface region 2122, the upper mold 22 may be turned counterclockwise about the second edge 2122′, thereby combining the upper mold 22 with the lower mold 21 (see also FIG. 9).

In some embodiments, the upper mold 22 includes a material with a self-releasable property. For example, the upper mold 22 may be made of the material with the self-releasable property, such as a silicon-based material or Teflon, but is not limited thereto. In some embodiments, the upper mold 22 may be made of a metallic material and is coated with the material with the self-releasable property.

Furthermore, in some embodiments, the pressing plate 23, which has a lower surface 231 larger than the upper surface 222 of the upper mold 22, is disposed on the upper surface 222 of the upper mold 22. Thereby, the molding material 4 is permitted to be evenly pressed against the upward depressed region 212 of the lower mold 21 through the downward pressing region 221 of the upper mold 22. In some embodiments, the pressing plate 23 is further pressed against the top surface 213 of the lower mold 21 to stabilize itself and to make distribution of downward pressure more uniform.

During hot pressing, the molding material 4 is deformed to fill in the mold cavity 24. In some embodiments, the molding material 4 is sandwiched between the downward pressing region 221 of the upper mold 22 and the mold release film 3 in position corresponding to the first surface region 2121, the interconnecting region 2123 and the extended surface region 2124 of the lower mold 21.

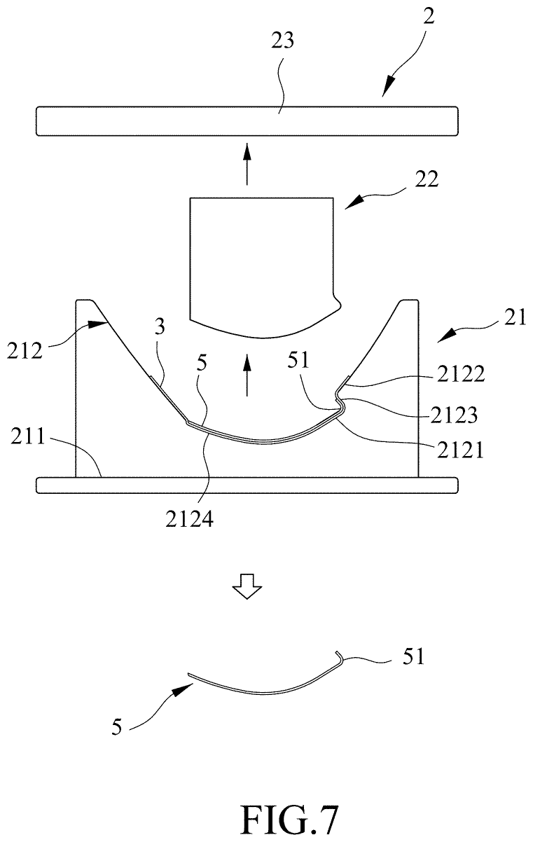

In step S4, the molding material 4 is formed into a molded composite 5 that has a profile 51 corresponding to the mold cavity 24. In some embodiments, the molded composite 5 is formed as a plate-shape, and the profile 51 thereof is substantially identical to a profile provided by the first surface region 2121, the interconnecting region 2123 and the extended surface region 2124, as shown in FIG. 7.

In step S5, as shown in FIG. 7, the pressing plate 23 and the upper mold 22 is removed sequentially, and then the molded composite 5 may be removed from the mold release film 3.

In some embodiments, as illustrated in FIG. 8, step S5 is performed by sliding the upper mold 22 inclinedly and upwardly relative to the interconnecting region 2123, thereby permitting removal of the upper mold 22 from the lower mold 21. In addition, because the guiding region 2125 is arranged substantially parallel to the interconnecting region 2123, the upper mold 22 may be guided by the guiding region 2125 to slide relative to the interconnecting region 2123 until the downward pressing region 221 is disengaged from the interconnecting region 2123. Thereafter, the upper mold 22 may be lifted upwardly.

In another embodiment, as illustrated in FIG. 9, step S5 is performed by rotating the upper mold 22 about the second edge 2122′ in a clockwise direction so as to move the downward pressing region 221 away from the first surface region 2121, thereby permitting removal of the upper mold 22 from the lower mold 21. In addition, because the angle (β) is not less than the angle (γ) (see FIG. 6), the downward pressing region 221 can be fully disengaged from the interconnecting region 2123 before or when the right-hand side region 223R is brought into pressing engagement with the second surface region 2122. As such, the upper mold 22 can be easily removed from the lower mold 21 by lifting upwardly. Finally, the mold release film 3 may be torn off from the upward depressed surface 212 of the lower mold 21.

The advantages of the method for manufacturing a molded composite of this disclosure can be summarized as follows.

Owing to the shape configuration of the lower mold 21 and the upper mold 22, the upper mold 22 can be easily moved apart from the lower mold 21 without interference. Furthermore, during the demolding process, no interference occurs between the molded composite 5 and the lower mold 21.

Configuration of the pressing plate 23 helps the upper mold 22 to press down evenly and stably without shaking during hot pressing.

Owing to the self-releasable property of the upper mold 22 and configuration of the mold release film 3, difficulty of the demolding process is further reduced, and no resin residue would be stuck on the downward pressing region 221 of the upper mold 22 or the upward depressed surface 212 of the lower mold 21.

To sum up, through the demolding process that is easy to be performed and without the residue of the molding material 4 being stuck on the mold 2, mass production of the molded composite 5 having the profile 51, such as a component of a golf club head, can be utilized with high production efficiency and low production cost.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making a molded composite, comprising the steps of:
a) providing a lower mold which has an upward depressed surface, and which defines a reference line normal to a bottom surface of the lower mold, the upward depressed surface having
a first surface region having a first edge most distal from the reference lin,
a second surface region located at the same side as the first surface region relative to the reference line, the second surface region having a second edge which is most proximate to the reference line and which is located at a level higher than that of the first edge, the second edge being closer to the reference line compared with the first edge, and
an interconnecting region interconnecting the first edge of the first surface region and the second edge of the second surface region;
b) placing a mold release film on the upward depressed surface to cover at least the first surface region, the second surface region, and the interconnecting region;
c) placing a molding material on the mold release film such that the mold release film is disposed between the upward depressed surface and the molding material; and
d) hot pressing the molding material by pressing a downward pressing region of an upper mold toward the upward depressed region of the lower mold so as to form the molding material into a molded composite.

2. The method of claim 1, wherein the upward depressed surface further has an extended surface region which extends from the first surface region away from the interconnecting region, and which permits the reference line to extend therethrough.

3. The method of claim 2, wherein, in step b), the mold release film is placed to further cover the extended surface region.

4. The method of claim 3, wherein the downward pressing region has a contour configured to hot press the molding material together with the first surface region, the interconnecting region, and the extended surface region.

5. The method of claim 3, wherein, in step d), a pressing plate, which has a lower surface larger than an upper surface of the upper mold, is disposed on the upper surface of the upper mold so as to permit the molding material to be evenly pressed against the upward depressed region of the lower mold through the downward pressing region of the upper mold.

6. The method of claim 1, wherein the upper mold includes a material with a self-releasable property.

7. The method of claim 6, wherein the upper mold is made of a metallic material and is coated with the material with the self-releasable property.

8. The method of claim 6, wherein the upper mold is made of the material with the self-releasable property.

9. The method of claim 6, wherein the material with the self-releasable property is selected from a silicon-based material or Teflon.

10. The method of claim 1, wherein the molding material is a resin impregnated material.

11. The method of claim 4, further comprising a step e) of removing the upper mold from the lower mold.

12. The method of claim 11, wherein step e) is performed by sliding the upper mold inclinedly and upwardly relative to the interconnecting region of the lower mold, thereby permitting removal of the upper mold from the lower mold.

13. The method of claim 11, wherein step e) is performed by rotating the upper mold about the second edge so as to move the downward pressing region of the upper mold away from the first surface region of the lower mold, thereby permitting removal of the upper mold from the lower mold.
